(19) United States
(12) Patent Application Publication
(10) Pub. No.: US 2008/0271629 A1
(43) Pub. Date: Nov. 6, 2008

(54) METHOD AND APPARATUS FOR HANDLING PRINTING PLATES ON A WEB-FED PRINTING PRESS

(75) Inventors: Annemarie FISCHER, Dinkelscherben (DE); Thomas Gsell, Dillingen (DE); Wolfgang Kaeser, Mertingen (DE); Rudolf Stroh, Duernau (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/113,682

(22) Filed: May 1, 2008

(30) Foreign Application Priority Data
May 2, 2007 (DE) 10 2007 020 528.9

(51) Int. Cl. B41L 43/14

(52) U.S. Cl. 101/477

(57) ABSTRACT

A method and apparatus for handling printing plates on a web-fed printing press is disclosed. Printing plates imaged on an imaging device are assigned a coding relating to the plate cylinder position of the printing couple at which the respective printing plate is used. Imaged printing plates are inserted into cassettes such that printing plates for several printing couples are positioned in each cassette, where each cassette is assigned a data record relating to the position at which each printing plate is arranged within the respective cassette. The loaded cassettes are conveyed to the region of the printing couples where the data record assigned to the cassettes is also made available in the region of the printing couples. The printing plates are removed from the cassettes and, with a comparison to the data record assigned to the respective cassette, supplied to the respective printing couples.

This application claims the priority of German Patent Document No. 10 2007 020 528.9, filed May 2, 2007, the disclosure of which is expressly incorporated by reference herein.

### BACKGROUND AND SUMMARY OF THE INVENTION

The invention relates to a method and apparatus for handling printing plates on a web-fed printing press.

In order to execute a printing plate change, it is necessary to manipulate printing plates on a web-fed printing press such as a newspaper printing press for example. In the case of web-fed printing presses known from practice, the procedure used is that printing plates imaged and thus produced in the region of an imaging device are brought manually by a printer to the region of the printing couple where the respective printing plate is used for printing, whereby the printer manually conveys the printing plates to the appropriate plate cylinders of the printing couples on which a printing plate change is supposed to be executed.

In addition, web-fed printing presses with automated printing plate changes are already known from practice, whereby, in the case of printing presses with automated printing plate changes, printing plates produced in the region of an imaging device are positioned in cassettes in order to remove the printing plates from the cassette in an automated manner during a printing plate change and convey them in an automated manner to the plate cylinders of the printing couples. In this case, a separate cassette is assigned to every printing couple of a web-fed printing press.

In both the case of printing presses with manual printing plate changes known from practice as well as web-fed printing presses with automated printing plate changes known from practice, printing plates can be mixed up easily and thus conveyed to the wrong printing couples or be arranged at the wrong plate cylinder position in the region of a printing couple.

Thus, it is possible, for example, for web-fed printing presses having automated printing plate changes known from practice to have the printing plates arranged in the wrong position within the cassette. In addition, it is possible for the cassettes to be positioned on the wrong printing couples. So far there are no web-fed printing presses known from the prior art which can preclude printing plates from being supplied during a printing plate change to the wrong printing couple or to the wrong plate cylinder position within a printing couple.

Starting herefrom, the present invention is based on the objective of creating a novel method for handling printing plates on a web-fed printing press as well as a novel web-fed printing press.

According to an embodiment of the invention, the method includes: a) printing plates are imaged on an imaging device, wherein each printing plate is assigned a coding relating to the plate cylinder position of the printing couple of the printing unit of a web-fed printing press at which the respective printing plate is used; b) imaged printing plates are inserted into cassettes in such a way that printing plates for several printing couples are positioned in each cassette, wherein each cassette is assigned a data record relating to the position at which each printing plate is arranged within the respective cassette; c) the cassettes loaded with printing plates are transported to the region of the printing couples, for which printing plates are positioned in the cassettes, wherein the data record assigned to the cassettes is also made available in the region of the printing couples; d) the printing plates are removed from the cassettes and, with a comparison to the data record assigned to the respective cassette, supplied to the respective printing couples to execute a printing plate change.

The present invention provides for the first time a continuously automated handling of printing plates starting from the imaging device to the printing couples on which the printing plates are used for printing. This prevents incorrect handling of printing plates, which can occur particularly with work steps that are performed manually, so that it is possible to guarantee that printing plates are always supplied to the correct printing couple as well as to the correct plate cylinder position within a printing couple. As a result, incorrect allocation of printing plates to plate cylinders of a web-fed printing press can virtually be ruled out.

Preferred developments of the invention are yielded from the following description. Without being limited hereto, one exemplary embodiment of the invention is explained in greater detail on the basis of the drawings.

### BRIEF DESCRIPTION OF THE DRAWINGS

FIG. 1 is a side view of a section of an inventive web-fed printing press; and

FIG. 2 is a side view of another section of an inventive web-fed printing press that has been rotated by 90° as compared to FIG. 1.

### DETAILED DESCRIPTION OF THE DRAWINGS

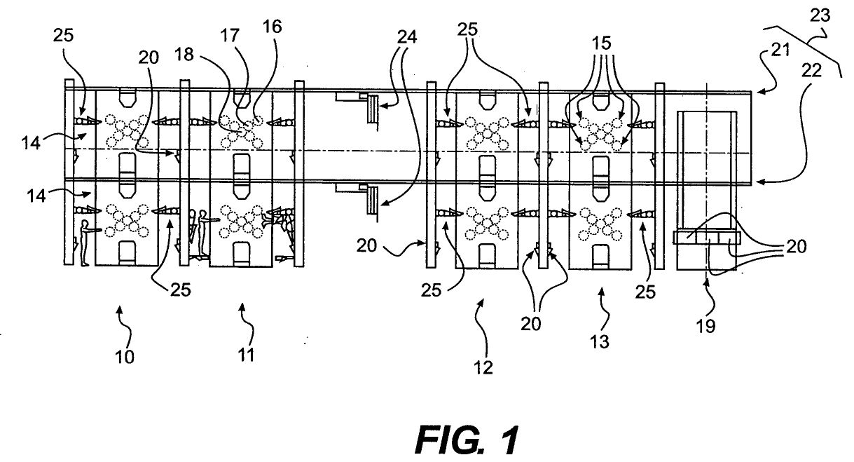

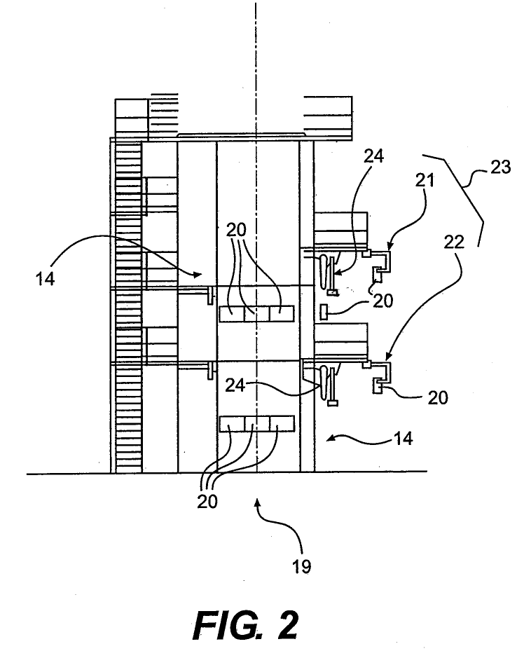

FIGS. 1 and 2 show different views of sections of an inventive web-fed printing press embodied as a newspaper printing press. Thus, FIG. 1 shows a total of four printing towers 10, 11, 12 and 13 from two vertically stacked printing units 14, wherein each of the printing units 14 of each printing tower 10, 11, 12 or 13 depicted in FIG. 1 has a total of four printing couples 15.

The plate cylinder 16 and the transfer cylinder 17 of each printing couple 15 are depicted schematically, wherein in the region of each printing unit 14 the transfer cylinders 17 of all printing couples 15 roll off a common impression cylinder 18. Consequently, the printing units 14 are what are commonly called 9-cylinder satellite printing units.

The printing units 14 of the printing towers 10 to 13 are used to print a web-shaped printing substrate, which is drawn off by a printing substrate roller in the region of a reel splicer (not shown) of the printing press. The printing substrate webs printed in the printing units 14 of the printing towers 10 to 13 start from the printing towers 10 to 13 and arrive in the region of a folding unit in order to form folds in the web-shaped printing substrate and/or in the copies separated from the web-shaped printing substrate by cross cutting.

The present invention deals with those details of a web-fed printing press that are related to the handling of printing plates required for printing, in particular for preparing as well as executing a printing plate change. In the case of a printing plate change on a printing couple 15 of a printing unit 14, old printing plates are removed from the plate cylinder 16 of the respective printing couple 15 and replaced with new printing plates.

To prepare for a printing plate change, printing plates are imaged and thus produced in the region of an imaging device (not shown) of the web-fed printing press. The procedure for this is that each printing plate is assigned a coding relating to the plate cylinder position of the printing couple 15 of the printing unit 14 of the web-fed printing press at which the respective printing plate is supposed to be used for printing. This coding is preferably an optically readable barcode or text code or a coding stored in a non-contact readable RFID tag.

The printing plates that are imaged and thus produced in the region of an imaging device (not shown) are preferably inserted into cassettes in the region of the imaging device, and namely in such a way that printing plates for several printing couples are positioned in each cassette. In this connection, positioned in each cassette are printing plates for two printing couples, namely for two vertically stacked printing couples 15 of a printing unit 14.

The printing plates are automatically positioned biuniquely in the cassettes by means of a manipulator arm embodied preferably in the region of the imaging device so that the position at which each printing plate is arranged within the respective cassette is always known. With this biunique arrangement of the printing plates in the cassettes, on the one hand, the coding assigned to the respective cassette is read out outside the respective cassette before the printing plate is inserted into the cassette in order to thereby check whether the correct printing plate is being loaded into the correct cassette. Furthermore, geometric parameters of the printing plate can be checked in this case in order to assure that a printing plate that is being inserted into a cassette is error-free.

In addition, with the biunique arrangement of the printing plates in the cassettes, a check is made within the cassette to see what position a printing plate that has been inserted into the cassette has assumed. In this case, a data record is generated for each cassette and assigned to the cassette, wherein the data record provides information about the position at which each printing plate is positioned in the respective cassette.

After the aforementioned automatic loading of the cassettes with the printing plates that are imaged in the region of the imaging device, the cassettes loaded with printing plates are conveyed to the region of the printing couples 15 of the printing press, for which printing plates are positioned in the cassettes.

In this case, not only the cassettes are made available to the corresponding printing couples 15 of the printing units 14, but also the data records assigned to the cassettes, wherein this can be accomplished in that either a readable storage device (preferably embodied as a RFID tag) that is physically assigned to the respective cassette is moved along with the cassette into the region of the appropriate printing couple or that the corresponding data records are made available to the printing couples 15 virtually as a data package.

Relocating the cassettes loaded with the printing plates to the region of the printing couples 15, for which printing plates are positioned in the cassettes, is accomplished by means of a conveyance device. The conveyance device encompasses a cassette lift 19 by means of which cassettes 20 can be moved in the vertical direction, namely raised and lowered, in order to thereby relocate the cassettes automatically to a horizontally running conveyance plane 21 or 22 of a cassette conveyor 23. After relocating cassettes 20 in the vertical direction to one of the conveyance planes 21, 22, the cassettes can be relocated horizontally within the conveyance planes 21, 22 in order to thereby relocate the cassettes to the region of the printing couples 15 of the printing unit 14, for which printing plates are arranged in the respective cassettes 20.

In addition to the cassette lift 19 and the cassette conveyor 23 having the two conveyance planes 21 and 22, the conveyance device also encompasses manipulator arms 24 in order to remove the cassette 20 from the cassette conveyor 23 when a cassette 20 is relocated to the region of the printing unit 14, for whose printing couples 15 printing plates are arranged in the cassette 20, and position it laterally next to the printing couples 15 of the printing unit 14. Like the cassettes 20, the manipulator arms 24 can be moved along the conveyance planes 21, 22 in the horizontal direction along the web-fed printing press in such a manner that a manipulator arm 24 can provide several printing units 14 that are positioned in a plane with cassettes 20.

After transferring a cassette 20 from a conveyance plane 21 or 22 of the cassette conveyor 23 laterally next to the printing couples 15 of a printing unit 14, for which printing plates are positioned in the cassette 20, an additional manipulator arm 25 serving these printing couples 15 can perform a printing plate change on the plate cylinders 16 of these printing couples 15 in that the manipulator arm 25 first automatically removes old printing plates from the corresponding plate cylinders 16 and then automatically conveys the printing plates being kept ready in the cassettes 20 to the plate cylinders 16. This is accomplished by using the data record assigned to the respective cassette 20 that contains information about the printing plates being kept ready in the cassette 20 in order to assure that printing plates are always conveyed to the correct plate cylinder 16 or to the correct plate cylinder position within the plate cylinder 16.

Old printing plates removed from the plate cylinders 16 by means of the manipulator arms 25 during a printing plate change are either disposed of in the region of the printing couples 15 or transferred in the corresponding cassette 20 in order to convey the old printing plates in an automated manner to a disposal station and to dispose of them centrally in the region of the disposal station.

As already mentioned, printing plates for several printing couples 15 are kept ready in a cassette 20, namely for two vertically stacked printing couples 15 of a printing unit 14. When, for example, four printing plates can be clamped on each plate cylinder 16, this means that each cassette 20 is keeping eight printing plates ready.

The cassettes 20 are designed in such a way that both single-width individual printing plates as well as multiple-width, particularly double-width, panorama printing plates can be accommodated. In addition, the cassettes 20 are designed to be variable format such that printing plates having different formats can be positioned therein regardless of whether these are individual printing plates or panorama printing plates.

The present invention guarantees automated or automatic handling of printing plates starting from the imaging device where the printing plates are imaged to the printing couples 15 where the printing plates are used for printing. In the process, where a particular printing plate is located can always be tracked, thereby allowing incorrect allocation of printing plates to plate cylinders to be ruled out.

### LIST OF REFERENCE NUMERALS

10 Printing tower
11 Printing tower
12 Printing tower
13 Printing tower
14 Printing unit
15 Printing couple
16 Plate cylinder
17 Transfer cylinder
18 Impression cylinder
19 Cassette lift
20 Cassette
21 Conveyance plane
22 Conveyance plane
23 Cassette conveyor
24 Manipulator arm
25 Manipulator arm

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for handling printing plates on a web-fed printing press, comprising the steps of:
a) imaging printing plates on an imaging device, wherein each printing plate is assigned a coding relating to a plate cylinder position of a printing couple of a printing unit of the web-fed printing press at which the printing plate is used;
b) inserting imaged printing plates into cassettes in such a way that printing plates for several printing couples are positioned in each cassette, wherein each cassette is assigned a data record relating to a position at which each printing plate is arranged within the respective cassette;
c) conveying the cassettes loaded with printing plates to a region of the printing couples, for which printing plates are positioned in the cassettes, wherein the data record assigned to the cassettes is also made available in the region of the printing couples; and
d) removing the printing plates from the cassettes and, with a comparison to the data record assigned to the respective cassette, supplying the printing plates to the respective printing couples to execute a printing plate change.

2. The method according to claim 1, wherein in step a) every printing plate is assigned the coding as an optically readable barcode or text code or as coding stored in a non-contact readable RFID tag.

3. The method according to claim 1, wherein in step b) the printing plates are positioned biuniquely in the cassettes.

4. The method according to claim 1, wherein in step b) all printing plates used on plate cylinders of two stacked printing couples of a printing unit are positioned in each cassette.

5. The method according to claim 1, wherein in step b) the inserting of the imaged printing plates into the cassettes is performed automatically by a manipulator arm.

6. The method according to claim 1, wherein in step c) the cassettes loaded with printing plates are moved automatically by a cassette lift vertically to a horizontally running conveyance plane of a cassette conveyor, wherein the cassettes are automatically conveyed by the cassette conveyor to a region of the printing unit, for which printing plates are arranged in the cassettes, and wherein, starting from the cassette conveyor, the cassettes are removed by a manipulator arm from the cassette conveyor and positioned laterally next to the printing couples of the printing unit, for which printing plates are arranged in the cassettes.

7. The method according to claim 1, wherein in step d) the printing plates are automatically removed from the cassettes by a manipulator arm and supplied to the respective printing couples to execute a printing plate change.

8. The method according to claim 1, wherein in step d) printing plates removed from plate cylinders during the printing plate change are disposed of in the region of the printing couples.

9. The method according to claim 1, wherein in step d) printing plates removed from plate cylinders during the printing plate change are automatically inserted into the cassettes, are automatically transported via the cassettes to a region of a disposal station, and in the region of the disposal station are automatically removed from the cassettes and disposed of.

10. A web-fed printing press, comprising:
a) an imaging device for imaging printing plates, wherein each printing plate is assigned a coding relating to a plate cylinder position of a printing couple of a printing unit of the web-fed printing press for which the respective printing plate is destined;
b) cassettes for accommodating imaged printing plates, such that, printing plates for several printing couples are positioned in each cassette, wherein each cassette is assigned a data record relating to a position at which each printing plate is arranged within the respective cassette;
c) a conveyance device which conveys cassettes loaded with printing plates to a region of the printing couples, for which printing plates are positioned in the cassettes, wherein the data record assigned to the cassettes is also made available in the region of the printing couples; and
d) manipulator arms assigned to the printing couples, which remove the printing plates from the cassettes and, with a comparison to the data record assigned to the respective cassette, supply them to the respective printing couples to execute a printing plate change.

11. The web-fed printing press according to claim 10, wherein the imaging device is assigned at least one manipulator arm in order to automatically insert imaged printing plates into the cassettes.

12. The web-fed printing press according to claim 10, wherein both single-width individual printing plates as well as multiple-width panorama printing plates are insertable into the cassettes.

13. The web-fed printing press according to claim 10, wherein the cassettes include printing plates having different formats.

14. The web-fed printing press according to claim 10, wherein the conveyance device includes a cassette lift which automatically moves cassettes vertically to a horizontally running conveyance plane of a cassette conveyor, wherein the cassettes are automatically conveyable by the cassette conveyor to the region of the printing couples of the printing unit, for which printing plates are arranged in the cassettes, and wherein, starting from the cassette conveyor, the cassettes are removable by a manipulator arm from the conveyance plane of the cassette conveyor and are positionable laterally next to the printing couples, for which printing plates are arranged in the cassettes.

15. A method for handling printing plates on a web-fed printing press, comprising the steps of:
imaging printing plates on an imaging device, wherein each printing plate is assigned a coding relating to a plate cylinder position of a printing couple of a printing unit of the web-fed printing;
inserting imaged printing plates into a cassette such that printing plates for two printing couples are positioned in the cassette, wherein the cassette is assigned a data record relating to a position at which each printing plate is arranged within the cassette;
conveying the cassette with the imaged printing plates to a region of the two printing couples; and
supplying the printing plates to the two printing couples based on the data record and the printing plate coding.
